(19) United States
(12) Patent Application Publication
(10) Pub. No.: US 2022/0233950 A1
(43) Pub. Date: Jul. 28, 2022

(54) Arcade-Style Video Game Controller

(71) Applicant: Adam Larson, Escanaba, MI (US)

(72) Inventor: Adam Larson, Escanaba, MI (US)

(21) Appl. No.: 17/157,509

(22) Filed: Jan. 25, 2021

(51) Int. Cl. A63F 13/245

(52) U.S. Cl. CPC A63F 13/245

(57) ABSTRACT

The arcade-style video game controller is a video game controller that has the outward appearance resembling that of an arcade controller, and is attuned to perform for video games, specifically shooting games. The controller has many ports to connect it to the gaming computer or console, and to provide ports to the user for external hardware and an audio port. Two important distinguishing features of the arcade-style video game controller are its maintainability and customizability. The box can be easily maintained since the top is a hinged lid, that can open up for the user to clean the insides of the controller or replace parts as necessarily. Furthermore, the box can be easily customized by the same lid, which is comprised of several layers whereby the user may insert interchangeable artwork to be displayed as the controller's top face.

### BACKGROUND

A game controller, gaming controller, or simply controller, is an input device used with video games or entertainment systems to provide input to a video game, typically to control an object or character in the game. Before the seventh generation of video game consoles, plugging in a controller into one of a console's controller ports were the primary means of using a game controller, although since then they have been replaced by wireless controllers, which do not require controller ports on the console but are battery-powered. USB game controllers could also be connected to a computer with a USB port. Input devices that have been classified as game controllers include keyboards, mouses, gamepads, joysticks, etc. Special purpose devices, such as steering wheels for driving games and light guns for shooting games, are also game controllers. There have been no products available as original equipment or as an aftermarket to address this problem.

Game controllers have been designed and improved over the years to be as user friendly as possible. For example, a controller design with its shoulder triggers that mimic actual triggers such as those found on guns, has become popular for shooting games. Some controllers are designed to be best for one type of game, such as steering wheels for driving games, or dance pads for dancing games. There have been no products available as original equipment or as an aftermarket to address this problem either.

There exists a need for an arcade-style video game controller that is not being met by any known or disclosed device or system of present that is both economical and easy and versatile to use.

### SUMMARY OF THE INVENTION

The arcade-style video game controller is a video game controller that has the outward appearance resembling that of an arcade controller, and is attuned to perform for video games, specifically shooting games. The controller has many ports to connect it to the gaming computer or console, and to provide ports to the user for external hardware (such as a computer mouse) and an audio port. There are two identical mouse ports on the sides of the controller, to allow the user to plug in the mouse on either the left or right side as according to preference or to the specific game. Two important distinguishing features of the arcade-style video game controller are its maintainability and customizability. The box can be easily maintained since the top is a hinged lid, that can open up for the user to clean the insides of the controller or replace parts as necessarily. Furthermore, the box can be easily customized by the same lid, which is comprised of several layers whereby the user may insert interchangeable artwork to be displayed as the controller's top face.

### BRIEF DESCRIPTION OF THE DRAWINGS

FIG. 1 is a view of the arcade-style video game controller along with a computer mouse, which can be used in tandem with the video game controller, in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

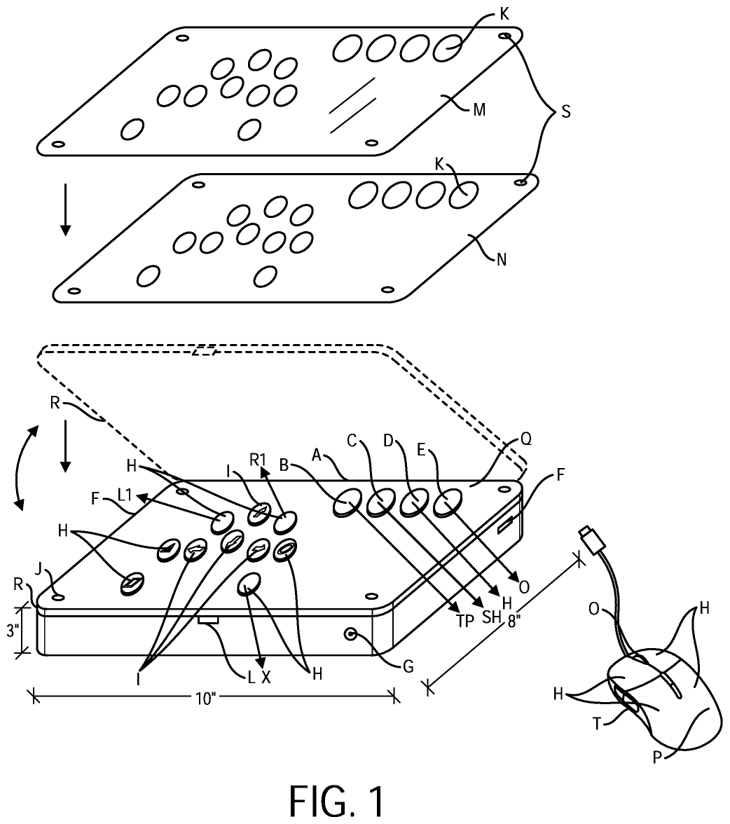

FIG. 1 is a view of the arcade-style video game controller along with a computer mouse, which can be used in tandem with the video game controller, in accordance with an embodiment of the present disclosure. The main board Q, has a variety of buttons to be used by the user in play, and ports to allow communication with other hardware devices (such as a computer mouse). One such port is a USB port A at the back of the board, to allow a connection to the computer or other gaming console controlling the play. Another port is the headset port G at the front of the board. Furthermore, there is one USB port F on each of the two board sides. This is to provide a connection to a computer mouse. A computer mouse can provide extra utility to the game controller with action input H by its buttons, or the mouse wheel for selecting button preference O. The game controller has buttons of its own, with a variety of action buttons H and directional input buttons I. Additionally, there is a button for touch pad input B, for share button input C, for home button input D, and for options or starting button input E.

In an embodiment of the disclosure, the arcade-style video game controller is designed for optimization and customization. The controller itself is a hinged box, whereby the lid can swing open if not held down by screws J, in the strategically placed holes S at the corners of the box, and when unlatched by the front release button L. By opening the hinged box lid R up, the user can clean the interior or replace parts as needed. The lid itself is made up of several component parts that may be disassembled for customization or cleaning. The top layer is a clear protective layer with cutouts K for the buttons and holes S for the screws. The second layer N is an interchangeable art piece with analogous cutouts for the buttons and holes for the screws. When constructed properly, that interchangeable art piece is visible through the protective top layer.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A video game controller comprising:
a box for a wireless electronics control and communications with a gaming system, the box comprising interfaces for input and output;
a hinged cover for the box and for an access into the box;
a mouse interface on at least one side of the box;
a touch screen on the box, the touch screen comprising a programmable touch pad input corresponding to a varying programmable button(s); and
a plurality of button templates corresponding to the varying programmable button(s) to direct a user's touch input to varying locations on the touch screen.

2. The video game controller of claim 1, further comprising a moveable cover for box and for an access into the box.

3. (canceled)

4. The video game controller of claim 1, further comprising a plurality of artwork templates comprising cutouts for the varying programmable buttons.

5. The video game controller of claim 1, further comprising a plurality of artwork templates comprising cutouts for a mouse and a mouse control wheel and buttons.

6. The video game controller of claim 1, further comprising a share button input and a home button input.

7. The video game controller of claim 1, further comprising an options button input and a start button input.

8. The video game controller of claim 1, further comprising an action button input and a direction button(s) input.

9. The video game controller of claim 1, further comprising a mouse button for touch pad input preference.

10. The video game controller of claim 1, wherein the plurality of button inputs comprise a template having a row of buttons comprising a touch pad TP button, a share SH button, a home H button and an options/start button.

11. The video game controller of claim 1, wherein the plurality of button inputs comprise a template having a cluster of buttons comprising an up button, a down button, a left button and a right button and two distal actions buttons L1 and R1.

12. The video game controller of claim 1, wherein the plurality of button inputs comprise a template having a cluster of directional buttons and four distal action buttons L1, R1, a triangular icon button and a rectangular icon button.

13. The video game controller of claim 1, wherein the plurality of button inputs comprise a template having a cluster of directional buttons and six distal action buttons L1, R1, a triangular and a rectangular and a circular icon button and an X button.

14. The video game controller of claim 1, wherein the box interfaces for input and output comprise a headset port on at least one side of the box.

15. (canceled)

16. The video game controller of claim 1, wherein the box interfaces for input and output comprise a universal serial bus interface on at least one side of the box.

17. The video game controller of claim 1, wherein the box interfaces for input and output comprise an auxiliary interface on at least one side of the box.

18. A video game controller comprising:
a box for an electronics control and communications with a gaming system, the box comprising wireless and wired interfaces for input and output:
a hinged cover for the box and for an access into the box;
a mouse interface on at least one side of the box;
a touch screen component of the box comprising a programmable touch pad input corresponding to a variety of programmable buttons; and
a plurality of button templates corresponding to the variety of programmable buttons directing a user's touch,
wherein the variety of programmable buttons vary in a location on the touch screen and a gaming function assigned thereto by the user.

19. The video game controller of claim 18, wherein the plurality of button templates comprise a template having a cluster of directional keys, a distal plurality of action input keys and a distal row of control keys.

20. The video game controller of claim 18, wherein the plurality of button templates comprise a template having a cluster of action keys, a distal plurality of control keys and a distal row of direction keys.
